(19) United States
(12) Patent Application Publication
(10) Pub. No.: US 2011/0290099 A1
(43) Pub. Date: Dec. 1, 2011

(54) Intuitive Electric Guitar Switching for Selecting Sounds of Popular Guitars

(76) Inventors: Michael S. Franklin, Leander, TX (US); Jonathan C. Stupka, Austin, TX (US)

(21) Appl. No.: 12/671,697

(22) PCT Filed: Aug. 8, 2008
(86) PCT No.: PCT/US2008/072706

§ 371 Date: Feb. 1, 2010

Related U.S. Application Data
(60) Provisional application No. 60/954,634, filed on Aug. 8, 2007.

(51) Int. Cl. G10H 3/10; G10H 3/00

(52) U.S. Cl. 84/733; 84/723

(57) ABSTRACT

A guitar-family-characteristic-sound selector switch (63) is incorporated into an electric guitar and used in conjunction with the normal guitar pickup selector switch (62) and the volume and tone controls. This guitar-family-characteristic-sound selector switch invokes different pickup (61) combinations and resistance/capacitance/inductance circuitry (68) in order to generate sounds characteristic of at least two other guitars in addition to the normal sound of the host guitar. In one implementation, the family selector switch is a single user controllable switch that makes the system is intuitive in that a single guitar-family-characteristic-sound selector switch is all that needs to be operated to put the guitar in the mode of sounding like one of three or more styles of guitars following such selection; the pickup selector, volume and tone controls are used in the usual manner.

This application claims the benefit of U.S. Application No. 60/954,634, filed Aug. 8, 2007, which is incorporated herein by reference.

### BACKGROUND OF THE INVENTION

Typically electric guitars have two or more magnetic coil pickups with a selector switch that selects individual or combinations of pickups to increase the range of sounds available with the guitar. These magnetic coil pickups tend to be either double coil “humbucking” or single coil style pickups. Different pickups produce different sounds due to their type, construction, number of coil windings and location on the guitar between the fingerboard and the bridge. Examples of electronic pickups are shown in U.S. Pat. Nos. 2,897,709 and 4,222,301; they are, of course, well known in this art.

Most guitars feature a single selector switch that activates 2, 3 or 5 different individual or combinations of coils. Some guitars have a second switch that provides a means to put selected pickups from the primary selector switch out of phase with each producing additional tonalities. A few guitars have individual on-off selector switches for each pickup on the guitar.

Up until now, providing additional tones has involved multiple switches complicating the user interface in the case of “passive” or non-electrical powered circuits. In the case of “active” electrical powered circuits, many additional sound envelopes can be covered, but there is the downside of further complicating the user interface and the risk that needed battery power may deteriorate at inopportune times during playing.

Overall, electric guitars can be grouped in different families where each family has a characteristic sound. There are three families that are most popular.

One family of guitars features a guitar with three single coil pickups and either a 3-way or 5-way selector switch to engage pickups and/or pickup combinations. An example of this guitar family is the Fender® Stratocaster®.

Another family of guitars features a guitar with two single coil pickups where the pickup selection, location and associated filtering circuit provide a bright “twangy” sound. An example of this guitar family is the Fender® Telecaster®.

A third family of guitars features a guitar with two or three double coil “humbucking” pickups or two or three P-90 style single coil pickups that produce a warm, rich sound, increased mid-range frequency response and output power. Examples of guitars in this guitar family include the Gibson® Les Paul®, Fender® Big Apple Stratocaster®, and Fender® Strat-O-Sonic®.

Although some musicians have a preference for the sound of a guitar in just one of these families, many musicians like to have a guitar from two or more of these families because they desire a particular characteristic sound for a particular piece of music. Up until now, in order to have access to the characteristics of sounds from two or more families of guitars, a musician had to:

(1) physically have two or more guitars,
(2) use external circuit devices to modify the pickup signal before final amplification in an attempt to mimic characteristic sounds of different guitar families, or
(3) deal with a complicated series of switches on the guitar to activate different pickup and pickup sound filter circuits in order to obtain the desired sound at a particular moment in playing.

For a working musician who does not have the luxury of a road crew, hauling around multiple guitars is problematic, as is being worried about unused guitars being damaged or stolen while performing with one guitar.

Moreover, there may be an instance where one piece of music ideally requires the tonality of sound from two different guitar families; such normally has had to be compromised because the musician cannot quickly or easily switch guitars during the piece of music absent the employment of external sound modifying devices.

U.S. Pat. No. 5,136,918 shows an electric guitar switching system where a number of pickups are provided and different tonalities can be selected using a two-gang, five-position switch for one tone selection wherein the switch employs two double contacting wipers and wherein, for mode selection, either a toggle or a push/pull double pull double throw switch is utilized. U.S. Pat. No. 5,311,806 discloses a switching system that is generally similar to the foregoing but uses a four-pole, five-position switch for tone selection which provides one-of-ten tonality selections in conjunction with a dual pole, double throw switch.

U.S. Pat. No. 5,780,760 utilizes a single coil, treble pickup, a single coil, middle pickup, and a single coil, rhythm pickup and a switch arrangement which allows the guitar player to select a variety of combinations of such outputs. U.S. Pat. No. 6,316,713 similarly shows a sound pickup switching system for an electrical guitar which permits the connection of the coils of the sound pickups in a variety of different combinations and which includes a voice signal production apparatus.

U.S. Pat. No. 6,781,050 shows a tonality selection switch which requires heavy modification of an existing guitar body and replaceable passive modules in order to provide different switching combinations. U.S. Pat. No. 6,121,537 provides a system for generating different tonality sounds from a single guitar which requires a special design four-coil humbucker pickups and three switches. U.S. Pat. No. 6,998,529 discloses a pickup switching system for a three pickup electrical guitar that is designed to select outputs of the pickups in some 29 series or parallel, in-phase and/or out-of-phase combinations which requires some six toggle switches and a five-way switch; it is not felt to be particularly user friendly.

As a result, for the musician who can only afford one guitar, currently the only option is to either limit the sound to one of the guitar families or to deal with complicated, non-intuitive, multiple pickup-selector switches.

### BRIEF SUMMARY OF THE INVENTION

Several embodiments of the invention provide various electronic assemblies and related methods for use with electric guitars and other stringed instruments. According to several embodiments, a system is provided which comprises a guitar-family-characteristic-sound selector switch (also referred to as a family selector switch or a guitar mode selector switch in some embodiments) that is used in conjunction with the normal pickup selector switch. This guitar-family-characteristic-sound selector switch invokes different pickup combinations and certain resistance/capacitance/inductance circuitry to generate the characteristic sound of the selected guitar family.

In accordance with one embodiment, this intuitive switch will generally have only three positions, one for each of the three most popular guitar families mentioned above. However, in other embodiments, this switch could have one or more additional positions to invoke characteristics sounds of still other guitar families.

In some embodiments, this switch might optionally also have a position to engage mounted piezoelectric pickups and corresponding amplifying/sound shaping circuitry sometimes added to an electric guitar to generate a acoustic guitar type sound.

Some embodiments are designed to be intuitive in that only the single guitar-family-characteristic-sound selector switch is moved or operated to put the guitar in the mode of sounding like a particular style of guitar. Then the guitar pickup selector switch, volume and tone controls are used in the usual manner.

Furthermore, in accordance with some embodiments, this system gives musicians the flexibility of having the tonal characteristics of multiple guitars with just one guitar in a passive electric mode where battery life is not a problem. The only time active electrical operation is required would be to engage acoustic-guitar-simulating piezoelectric pickups that require a signal boost before reaching external amplifiers.

In one embodiment, the invention can be characterized as an electronic assembly for use with an electric guitar comprising one or more coil pickups; a pickup selector switching circuit coupled to the one or more coil pickups and operable to engage a whole and/or a portion of a coil pickup individually as well as to engage combinations of two or more of the coil pickups; and a volume control circuit. The assembly also comprises a family selector switch; and a family selector switching circuit coupled to the family selector switch and the pickup selector switching circuit, wherein user manipulation of the family selector switch changes an intonation of the electric guitar so as to alternately mimic a characteristic sound of each of a plurality of guitar families.

In another embodiment, the invention can be characterized as a method of operating an electric guitar comprising the steps: manipulating a pickup selector switch of the electric guitar to cause the electric guitar to selectively engage one or more of a plurality of coil pickups; and manipulating a family selector switch of the electric guitar to change an intonation of the electric guitar so as to alternately mimic a characteristic sound of each of a plurality of guitar families.

In a further embodiment, the invention may be characterized as a method of operating an electric guitar comprising the steps: selectively engaging one or more of a plurality of coil pickups of an electric guitar; and selectively establishing a predetermined electrical arrangement of the one or more coil pickups to mimic a respective pickup arrangement corresponding to a selectable one of a plurality of guitar families; filtering signaling received from the predetermined electrical arrangement of the one or more coil pickups using a predetermined filter corresponding to the selectable one of the plurality of guitar families; adjusting a volume of the signaling; and outputting the signaling to audio equipment.

In a further embodiment, the invention may be characterized as a method of designing an electronic assembly for use in an electric guitar comprising the steps: (a) determining a pickup arrangement to mimic that corresponds to each one of a plurality of guitar families; and for each pickup arrangement, (b) forming an electrical series parallel arrangement of an available one or more coil pickups that corresponds to the pickup arrangement; (c) measuring resistance, capacitance and inductance characteristics of the pickup arrangement to be mimicked; (d) measuring resistance, capacitance and inductance characteristics of electrical series parallel arrangement intended to mimic the pickup arrangement; (e) modeling the measured characteristics of steps (c) and (d); (f) plotting frequency response curves based on step (e); (g) determining a difference between a first frequency response curve corresponding to the pickup arrangement and a second frequency response curve corresponding to the electrical series parallel arrangement; and (h) adding filter components to the electrical series parallel arrangement to make the second frequency response curve substantially match the first frequency response curve

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a schematic drawing of a popular electric guitar (1) having a three single-coil-style pickups, an actuator (2) for a five-way pickup selector switch, a knob (3) for a volume control and knobs (4 and 5) for two tone controls.

FIG. 2 is a schematic drawing of another popular electric guitar (6) of a different style, having two single-coil-style pickups, an actuator (7) for a pickup selector switch, a knob (8) for a volume control and a knob (9) for tone control.

FIG. 3 is a schematic drawing of yet another popular electric guitar (10) of a still different style having two double-humbucking-coil pickups, an actuator (11) for a pickup selector switch, two volume control knobs (12 and 13) and two tone control knobs (14 and 15).

FIG. 4 is a schematic drawing of one embodiment of a guitar (16) modified so as to embody various features of the invention in accordance with one embodiment.

FIG. 5 is a simplified electrical schematic drawing showing circuitry embodying various features of the invention which is designed for incorporation into the guitar of FIG. 4.

FIG. 6 is a functional block diagram illustrating various components of an electronic assembly for an electric guitar in accordance with several embodiments of the invention.

FIG. 7 illustrates two stacked coil pickups in one electrical arrangement according to one embodiment.

FIG. 8 illustrates the two stacked coil pickups of FIG. 7 in another electrical arrangement according to one embodiment.

FIG. 9 is an electrical circuit diagram of suitable circuitry for one embodiment of an electronic assembly for an electric guitar based on a guitar family having three single coil pickups.

FIG. 10 is a flowchart illustrating steps performed in accordance with several embodiments of the invention.

FIG. 11 is an electrical circuit diagram of suitable circuitry for another embodiment of an electronic assembly for an electric guitar based on a guitar family generally having two single coil pickups.

FIG. 12 is an electrical circuit diagram of suitable circuitry for another embodiment of an electronic assembly for an electric guitar based on a guitar family generally having two humbucking double coil pickups.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION OF THE INVENTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

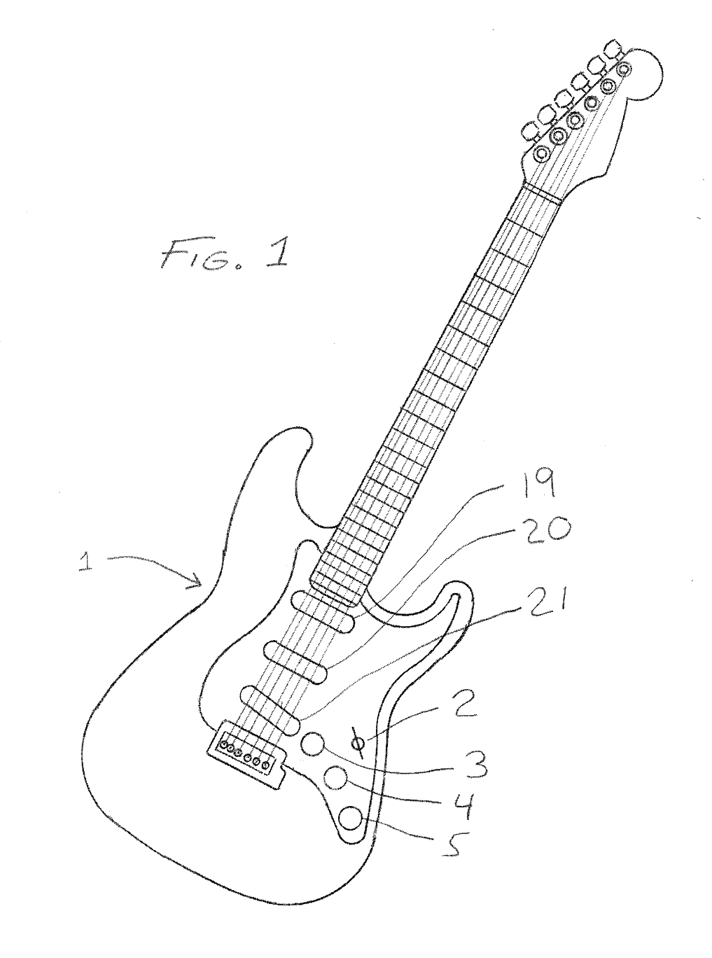

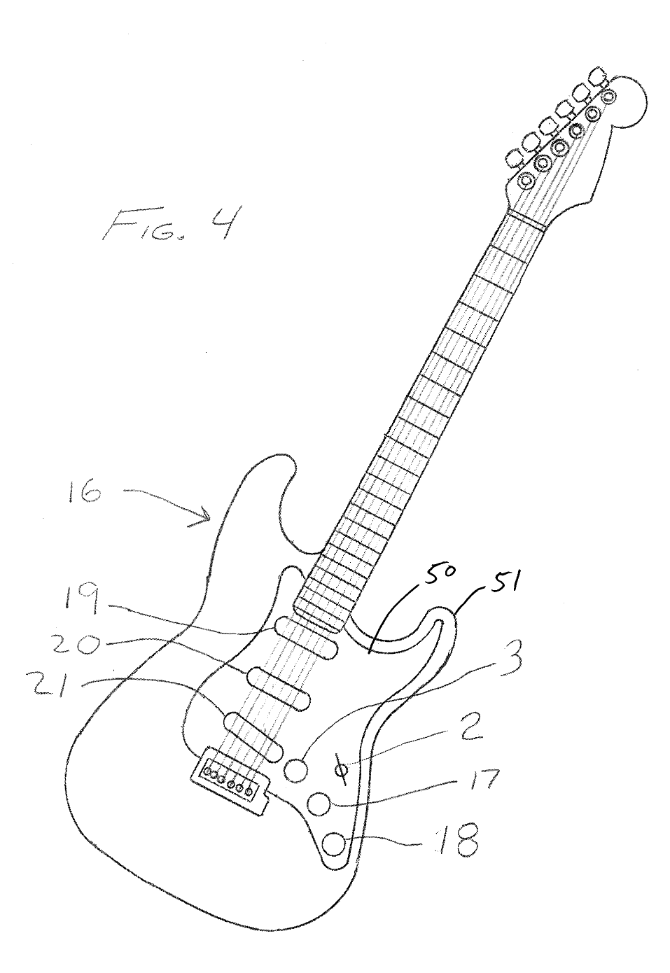

As indicated above, FIGS. 1, 2 and 3 are schematic drawings of three different of guitars; representing the three most popular electric guitar families at this present time. It is felt that any one of these three and others can be modified so as to incorporate particular features of embodiments of the present invention and as a result allow the player to intuitively make selections that will then generate the characteristic sound of a particular one of a particular guitar family. Disclosed in FIGS. 4, 5, 6 and 9 are a schematic drawing of a guitar 16, which is similar to the guitar one shown in FIG. 1, and the schematic drawings of electrical circuitry embodying various features of some embodiments of the present invention which may be incorporated in the guitar 16 of FIG. 4.

The guitar of FIG. 1 is an example representative of the Fender® Stratocaster® guitar family (hereinafter referred to as the Stratocaster® family) which has a slidable actuator 2 for a pickup selector switch 2 and three rotatable knobs 3, 4 and 5 for volume control, and tonal controls. The guitar has three single coil pickups 19, 20 and 21 which may be of any commercially available design such as that described in U.S. Pat. No. 4,222,301.

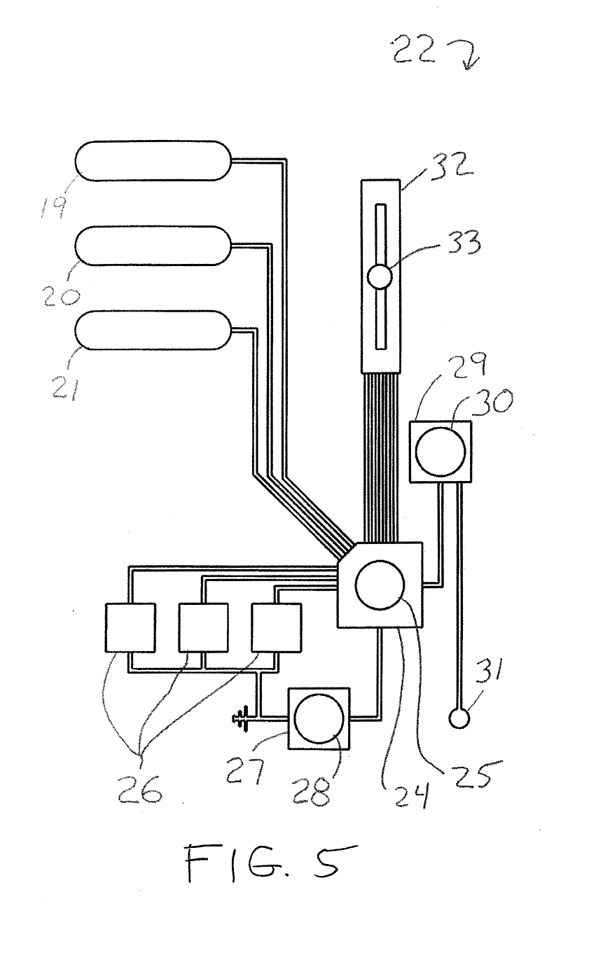

The embodiment of the guitar 16 in FIG. 4 includes the three single coil pickups 19, 20 and 21 (also referred to as single coil magnetic pickups) and retains the volume control knob 3 and one tone control knob 18, but the neck pickup tone control knob 4 is replaced with a knob or actuator 17 for a selector switch 24. Through the exemplary electrical circuitry 22 schematically depicted in FIG. 5, the selector switch 24, which is referred to as the guitar-family-characteristic-sound selector switch (also referred to simply as the family selector switch or a guitar mode selector switch), is connected to the pickup selector switch 32, the coil pickups 19, 20 and 21, the volume control potentiometer 29, and the remaining tone control potentiometer 27. In this embodiment, the selector switch 24 has a rotary knob 17 and can either be a standard tone control knob or a similar looking knob with selector markings to indicate the particular guitar-family-characteristic-sound that will be produced. Although other operable selective mechanisms could be employed, the rotary knob is traditional, and thus players may be more comfortable with this knob design. The guitar 16 includes a pickguard 50 which may be removed from a body 51 of the guitar 16. Typically, the pickguard 50 functions as a mounting structure having an electronic assembly coupled thereto, the electronic assembly including the pickups 19, 20 and 21, knobs, selectors and the other switching circuits.

The guitar 16 of FIG. 4 is configured like a guitar belonging to the guitar family having three single coil pickups, such as the traditional Stratocaster® guitar family; however, user manipulation of the selector switch 24 will cause the guitar 16 to sound like or mimic a guitar from another guitar family. For example, according to several embodiments, an electronic assembly is provided to allow the guitar of one guitar family (e.g. the Fender® Stratocaster® guitar family illustrated in FIG. 4) to mimic the pickup arrangement and characteristic sound of a guitar from two or more guitar families. In some embodiments, this electronic assembly is mounted to the pickguard which can be inserted into a guitar body.

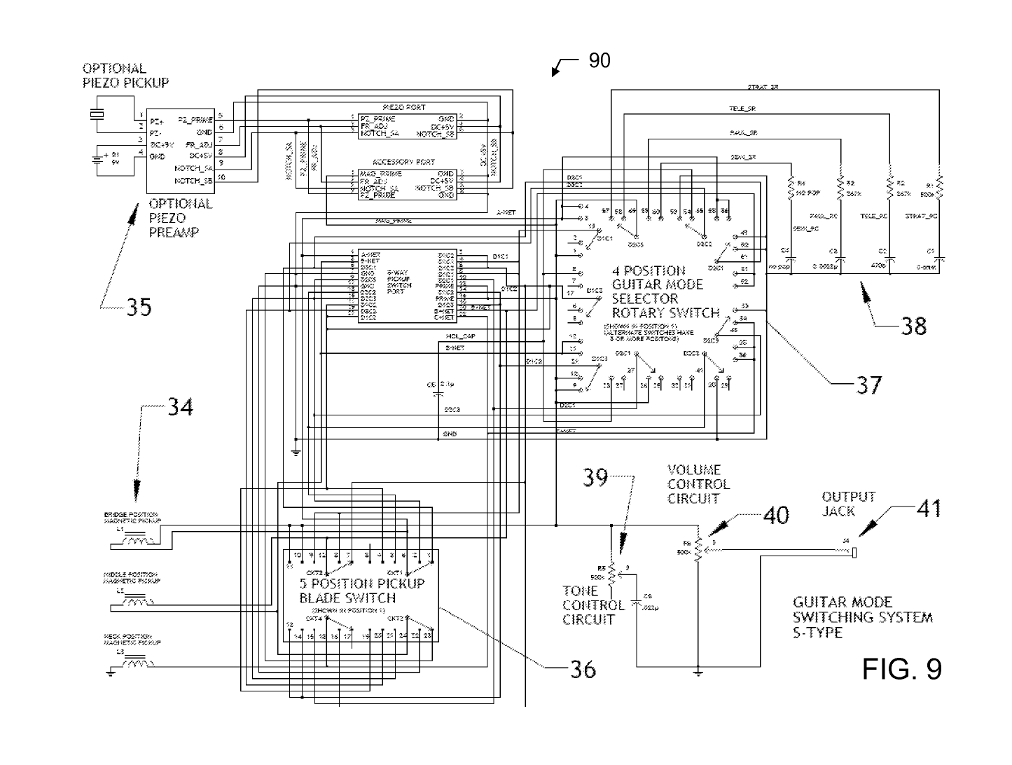

In operation, when the guitar-family-characteristic-sound selector switch 24 is placed in one position, the circuitry schematic 22 (see FIG. 5, for example) and detailed circuitry (see FIG. 9, for example) operate to make the guitar 16 of FIG. 4 sound like an unmodified, three single coil pickup electric guitar, such as a guitar of the Fender® Stratocaster® guitar family. It can be played in the same manner as such, except that the one tone control knob 18 (see FIG. 4) provides tone control covering all three of the coil pickups, instead of the usual unmodified configuration where the tone control knob 4 would provide tonal coloration to the neck pickup 19 and the tone control knob 5 would provide tone control to the middle pickup 20.

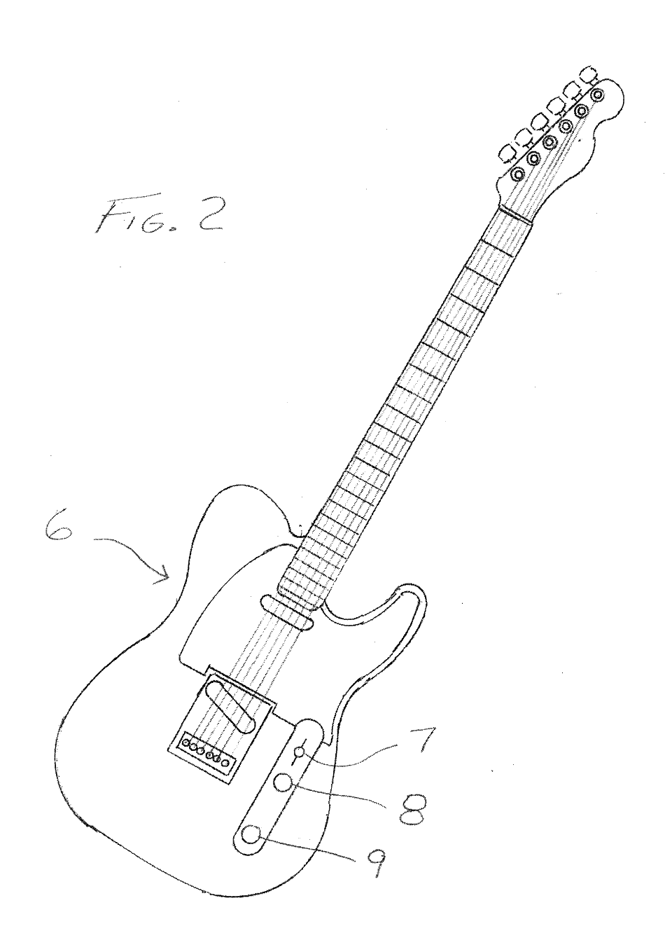

When the guitar-family-characteristic-sound selector switch 24 is moved to a second position, the circuitry schematic 22 (see FIG. 5) and detailed circuitry (see for example, FIG. 9) operate to make the guitar 16 of FIG. 4 sound like a member of the family characterized by a two single coil pickup configuration that produces a bright, mid-range focused, twangy sound, such as the Fender® Telecaster® guitar family (hereinafter referred to as Telecaster® family). A popular example of this guitar family is the guitar 6 in FIG. 2. With the selector switch 24 in this mode, the modified guitar operates just like a guitar in this family with the exception that the five-way pickup selector switch 32 offers two more pickup selection options than the three-way pickup selector switch commonly found in the FIG. 2 guitar. For example: when the selector switch 32 is in position 1, the equivalent bridge coil pickup is selected; when the selector switch 32 is in position 5, the equivalent neck coil pickup is selected; and when the selector switch 32 is in position 3 or the middle position, both of the equivalent bridge and neck coil pickups are selected. In some embodiments, positions 2 and 4 are used to add an additional sound to the guitar.

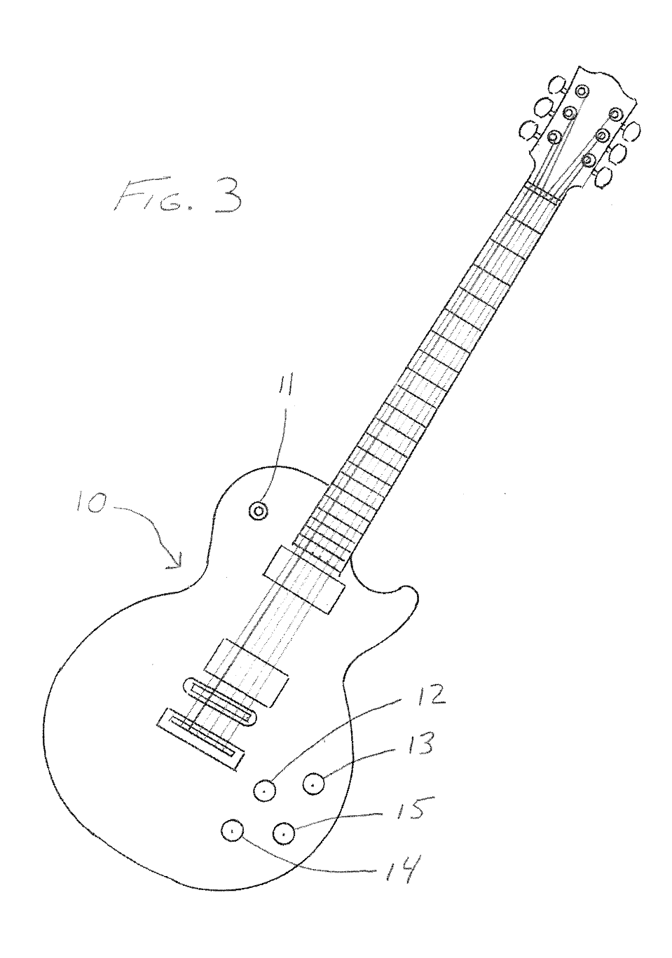

When the guitar-family-characteristic-sound selector switch 24 is moved to a third position, the circuitry schematic 22 (see FIG. 5) and detailed circuitry (see for example, FIG. 9) operate to make the guitar 16 of FIG. 4 sound like a member of the two or three double-coil “humbucking” pickup and/or two or three P-90 type single coil pickup guitar family that produces a rich full body sound, such as the Gibson® Les Paul® family (hereinafter referred to as the Les Paul® family). It is understood that the Les Paul® as used herein also includes similar guitars such as the Fender® Big Apple Stratocaster®, and the Fender® Strat-O-Sonic®. A popular example of this guitar family is the guitar 10 of FIG. 3. With the switch in this mode, the modified guitar 16 of FIG. 4 generally operates like a guitar in this family, with the exception that the five-way pickup selector switch 32 again offers two more pickup selection options than would be available via the actuator 11 for the three-way pickup selector switch commonly found on these guitars. For example: when the selector switch 32 is in position 1, the equivalent bridge humbucker coil pickup is selected; when the selector switch 32 is in position 5, the equivalent neck humbucker coil pickup is selected; and when the selector switch 32 is in position 3 or the middle position, both of the equivalent bridge and neck humbucker coil pickups are selected. In some embodiments, positions 2 and 4 are used to add an additional sound to the guitar. Again, the one tone control knob 18 in FIG. 4 will change the tonality of all engaged pickups, rather than having separate rotary tone control knobs 14 and 15 for each pickup as in the common Les Paul® guitar family.

Representative circuitry 22 as schematically depicted in FIG. 5 may comprise a multi-pole, preferably board mount type switch that constitutes the guitar-family-characteristic-sound selector switch 24. A linkage 25 connects to the actuator knob 17 and is preferably designed for rotary action, with detents for each position requiring a light, though positive activation force. The coil pickups 19, 20 and 21, the 5-position, 2-pole pickup selector switch 32 with its linkage 33 to the actuator 2 (e.g., see FIG. 4), the volume control unit 29 with its linkage 30 to the knob 3 (e.g., see FIG. 4), the tone control unit 27 with its linkage 28 to the knob 18 (e.g., see FIG. 4) and sound filter circuitry 26 are all electrically connected to the multi-pole, board-mounted selector switch 24.

As is described more fully below, inductance, winding capacitance, winding DC resistance and resonant frequency are all factored into the selection of the coil pickups 19, 20 and 21 that are preferably used with this device. Resistance/capacitance/inductance circuits (which may be generically referred to as filter circuits) are provided as a part of the sound filter circuitry 26, and they are selectively employed in each of the three guitar-family-characteristic-sound selector switch positions in order to most closely match the characteristic sounds of the different guitar families. That is, there is a filter circuit that corresponds to each position of the selector switch 24 and which fine tunes the audio signaling in order that the guitar 16 can closely mimic the guitar family characteristic sound selected with the selector switch 24.

Alternatively, if it should be desired to retain the standard two rotary tone controls, the guitar-family-characteristic-sound switch and its rotary actuator 17 may be located in another suitable position on the pickguard 50.

An alternative embodiment would feature an additional selection position and detent to the guitar-family-characteristic-sound switch. This additional position could be used to provide a sound replicating a family of electric semi-hollow body guitars. As another alternate, an additional position of the selector switch 24 could engage piezo-electric type pickups that would be used in conjunction with the 3 single-coil pickups 19, 20 and 21, in order to provide a sound replicating the family of amplified acoustic guitars. Or a fifth selector switch position could be employed to offer both of these families of guitars.

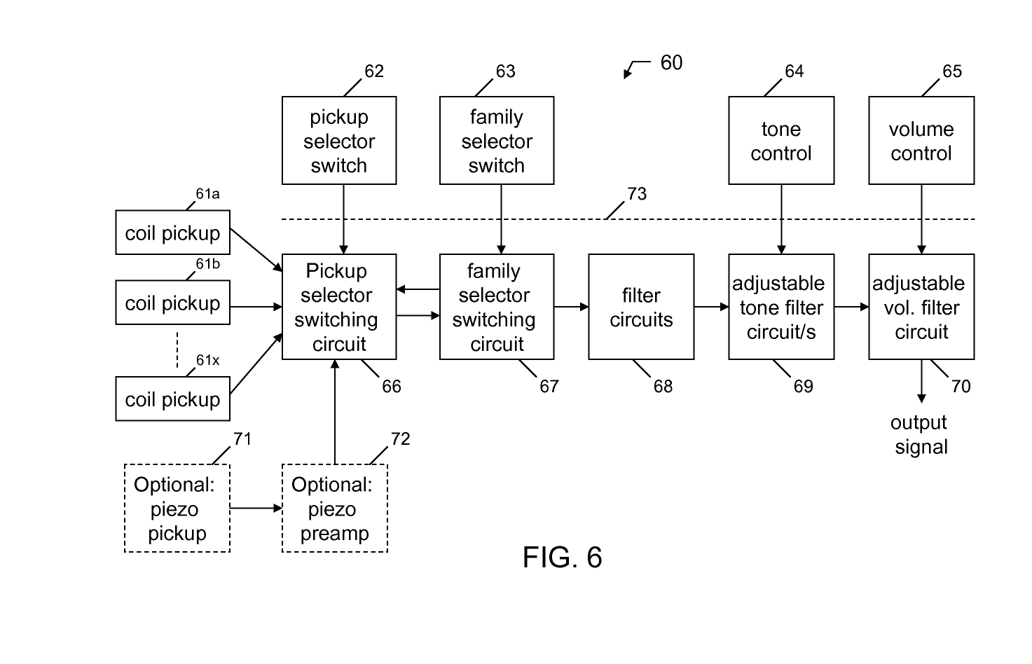

Referring next to FIG. 6, a functional block diagram is shown that illustrates various components of an electronic assembly 60 for an electric guitar in accordance with several embodiments of the invention. The diagram of FIG. 6 is meant to be a generic representation of the circuitry of FIG. 5 according to several embodiments and independent of the particular family of guitar that the electronic assembly is modeled after. The assembly 60 includes one or more coil pickups 61 (shown are magnetic coil pickups 61a, 61b through 61x), a pickup selector switch 62, a family selector switch 63 (also referred to as guitar-family-characteristic-sound selector switch or a guitar mode selector switch), a tone control 64, and a volume control 65. The assembly also includes a pickup selector switching circuit 66, a family selector switching circuit 67 (also referred to as a guitar-family-characteristic sound selector switching circuit or a guitar mode selector switching circuit), filter circuits 68, an adjustable tone filter circuit 69 and an adjustable volume filter circuit 70. The assembly 60 also includes an optional piezo pickup 71 and an optional piezo preamplifier 72. Dashed line 73 represents the separation between the user manipulatable controls and the circuitry coupled thereto.

In several embodiments, the electronic assembly 60 will be in the general configuration of a guitar of one of a plurality of guitar families. For example, the guitar 16 of FIG. 4 is configured as a guitar of the Stratocaster® guitar family having three single coil pickups. The initial family configuration of the guitar will dictate at least the number and type of coil pickups 61 and the pickup selector switching circuit 66. For example, the electronic assembly 60 for the guitar 16 of FIG. 4 would be such that the coil pickups 61 include three single coil pickups and the pickup selector switch 62 and switching circuit 66 would be a five-way pickup selector switch and five-way switching circuit. In another example, the electronic assembly 60 for a guitar configured as a Telecaster® family guitar would be such that the coil pickups 61 include two coil pickups and the pickup selector switch 62 and switching circuit 66 would be a five-way pickup selector switch and five-way switching circuit. In a further example, the electronic assembly 61 for a guitar configured as a Gibson® Les Paul® family guitar would be such that the coil pickups 61 include two or more humbucking coil pickups and the pickup selector switch 62 and switching circuit 66 would be a three-way or more pickup selector switch and three-way or more switching circuit. User manipulation of the pickup selector switch 62 causes the pickup switching circuit 66 to switch between different pickup combinations or emulated pickup combinations.

The family selector switch 63 and the family selector switching circuit 67 function together with the pickup selector circuit 66 and the filter circuits 68 to cause the guitar to alternately mimic a characteristic sound of guitars of each of a plurality of guitar families. For example, in some embodiments, user manipulation of the family selector switch 63 causes the guitar to sound like the guitar of a selectable one of the plurality of guitar families. In one embodiment, the family selector circuit 67 works with the pickup selector circuit 66 to establish a predetermined electrical arrangement of one or more coil pickups 61 to mimic a respective pickup arrangement that corresponds to each of the plurality of guitar families.

For example, in the embodiment of FIG. 4 configured similar to a guitar of the Stratocaster® guitar family, through the appropriate series parallel coupling of the available three single coil pickups, the pickup selector switching circuit 66 and the family selector switching circuit 67 cause the three available single coil pickups to selectively mimic the pickup arrangement of a guitar of the Telecaster® guitar family and the pickup arrangement of the Les Paul® guitar family, respectively. That is, in one embodiment, the three available single coil pickups are coupled so as to emulate the two single coil pickups of the Fender® Telecaster® and to also mimic the two or more humbucking double coil pickups (or P-90 style single coil pickups) of the Les Paul® family.

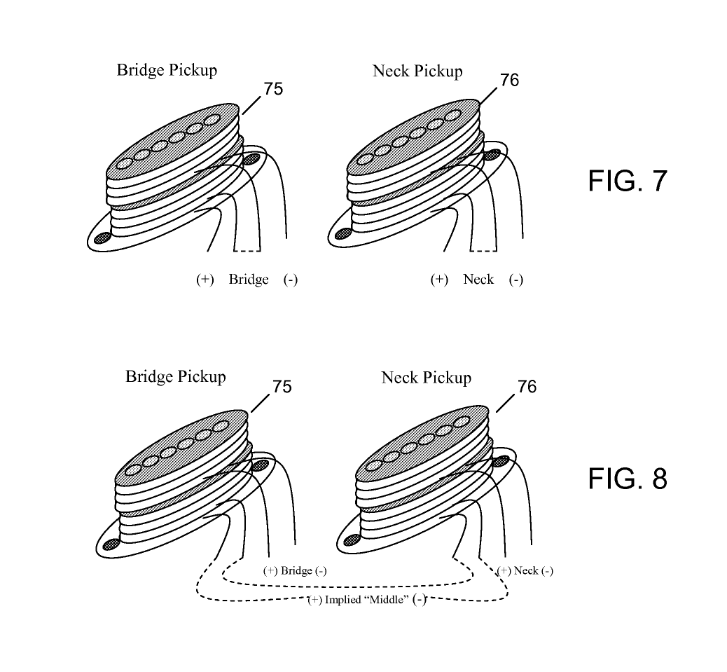

In another example, the electronic assembly is configured as a guitar having two single coil pickups such as the Telecaster® guitar family. In this case and in several embodiments, rather than use two traditional single coil pickups for the pickups 61, this version of the electronic assembly uses two stacked coil pickups for the pickups 61. As is known, each stacked coil pickup is actually two coils wired in series and that function as one coil. An illustration of two stacked coil pickups including the bridge coil pickup 75 and the neck coil pickup 76 is shown in FIG. 7. As seen, the upper and lower coils are coupled in series to function as two single coil pickups normally found in a guitar of the Telecaster® family but without the 60 cycle hum normally associated with the Telecaster®. Through the appropriate series parallel coupling of the available two stacked coil pickups 61, the pickup selector switching circuit 66 and the family selector switching circuit 67 cause the two available stacked coil pickups to selectively mimic the pickup arrangement of a guitar of the Stratocaster® guitar family and the pickup arrangement of the Les Paul® guitar family. That is, in one embodiment, the available two stacked coil pickups are coupled in an appropriate series parallel arrangement so as to emulate the three single coil pickups of the Stratocaster® and to also mimic the two humbucker coil pickups of the Les Paul® family. For example, as illustrated in FIG. 8, when the family selector switch 63 is positioned to select the Stratocaster® family, the pickup selector switching circuit 66 and the family selector switching circuit 67 will connect the coils to emulate the pickup arrangement of the Stratocaster® family. That is, the upper coils of the bridge and neck stacked coil pickups 75 and 76 emulate the bridge and neck single coil pickups of the Stratocaster® family. The lower coils of the pickups 75 and 75 are electrically coupled in series to emulate the middle pickup of the Stratocaster® family. Further, the emulated middle pickup of the Stratocaster® family in FIG. 8 is electrically coupled in various series parallel circuits with the upper coils of the bridge and neck stacked coil pickups 75 and 76 to emulate two humbucker coil pickups of the Les Paul® family in similar fashion as to the afore mentioned embodiment utilizing three single-coil pickups.

In another example, the electronic assembly is configured as a guitar having two or more humbucking double coil pickups, such as with the Les Paul® guitar family. In this case, through the appropriate series parallel coupling of the available two humbucking dual coil pickups, the pickup selector switching circuit 66 and the family selector switching circuit 67 cause the two available humbucker coil pickups to selectively mimic the pickup arrangement of a guitar of the Stratocaster® guitar family and the pickup arrangement of the Telecaster® guitar family. That is, in one embodiment, the two available humbucking double coil pickups are coupled so as to emulate the three single coil pickups of the Stratocaster® and to also mimic the two single coil pickups of the Telecaster® family. In some embodiments, since each humbucker coil pickup is actually two coil pickups, the pickup selector switching circuit 66 and the family selector switching circuit 67 will connect the various coils of the two humbucker coil pickups to emulate the pickup arrangement of the other families. In the case of the Stratocaster® family, similar to that illustrated in FIGS. 7 and 8 (except that the double coils of a humbucker pickup are side by side), one coil of the bridge humbucker pickup coil is wired to emulate the single coil bridge pickup of the Stratocaster®, one coil of the neck humbucker pickup coil is wired to emulate the single coil net pickup of the Stratocaster®, while the other two coils of the bridge and neck humbucker coil pickups are coupled in series to emulate the single coil middle pickup of the Stratocaster®.

It is noted that the number of coil pickups 61 depends on the base model guitar that the electronic assembly is modeled after. Furthermore, the pickup selector switching circuit 66 can engage a whole coil pickup, a portion of a coil pickup and/or combinations of coil pickups. A portion of a pickup may be engaged be coupling to a particular coil of the coil pickup (in the case of a multiple coil pickup), or by using a tap to effectively select a portion of a given coil of the pickup. For example, a coil tap may be used to effectively split a single coil pickup into two electrically different coils. Thus, in a broad sense, the electronic assembly of some embodiments includes one or more coil pickups 61, the arrangement of which can be altered to mimic a pickup arrangement of a guitar of a guitar family to be emulated or mimicked.

In many embodiments, the series parallel arrangement of the available coil pickups is switchable to emulate the pickup arrangement of the other guitar families causing the guitar to sound similar to the additional guitar families. However, filter circuits 68 are provided in order to make fine adjustments to the signaling so that the guitar will most closely mimic a guitar of the desired guitar family. Thus, the filter circuits 68 operate together with the family selector switching circuit 67 and the predetermined electrical arrangement of the one or more coil pickups to cause the change of the intonation of the guitar so as to alternately mimic the characteristic sound of each of the plurality of guitar families. In one implementation, there is a separate filter circuit that corresponds to each of the guitar families. That is, when a given family is selected by the user operating the family selector switch 63, the family selector switching circuit 67 switches the signaling through the particular filter circuit corresponding to the given family. In preferred form, the filter circuits comprise resistance and capacitance (RC) circuits, but function together with the inductance of the coil pickups to provide a resistance, inductance and capacitance (RLC) circuits. Additionally, in preferred form, the filter circuits 68 are passive in that no external power is needed. Such preferred embodiments are simple to use for the user and eliminate the risk that power needed for an active circuit will fail during use. Alternatively, some embodiments use active filter circuits to fine tune the signaling to best match the desired guitar family.

In operation, the coil pickups 61 output a low voltage AC signal when the instrument strings vibrate. The pickup selector switch 62 and family selector switch 63 work in tandem to combine the pickup AC signals in series and/or parallel effective circuits as appropriate per each desired “guitar mode” (selected by the family selector switch 63) and “pickup selection” (selected by the pickup selector switch 62) along with assigning specific filter circuits 68. The resulting AC signal is then fed to the adjustable tone filter circuit 69 (e.g., a variable attenuation passive low-pass filter) controllable by the user through manipulation of the tone control 64 (e.g., at least one knob 18). The AC signal is also fed to the adjustable volume filter circuit 70 (e.g., a variable attenuation to ground volume control circuit) controllable by the user through manipulation of the volume control 65 (e.g., the knob 3). The resulting output AC signal is then routed to an output connector where the AC signal is input into currently available amplification and loudspeakers to produce desired volume. When in a given family mode selected by the family selector switch, further user manipulation of the pickup selector switch 62 causes the pickup selector switching circuit 66 to effectively select between the emulated pickup arrangement formed from the available coil pickups.

In several embodiments, the family selector switch 63 is embodied as a single user controllable switch. This provides for a comfortable simple user interface that is easy to operate from the user's standpoint. Thus, the user is not required to manipulate multiple or complicated controls (toggles, knobs, buttons, etc.) to quickly change the intonation of the guitar from the characteristic sound of one guitar family to another guitar family. In some embodiments, the single user controllable switch may include multiple actuators but still function as one switch. For example, in one embodiment, the family selector switch 63 comprises three push buttons that when one is depressed, the others are not pressed. Additionally, in some embodiments, the family selector switch 63 is configured to replace an existing user control normally found in a guitar of the family that the guitar to be configured as. For example, in guitar 16, the family selector switch 17 replaces the tone control knob 4.

Optionally, piezo pickups 71 and the piezo preamplifier 72 may be coupled to the pickup selector switching circuit 66 and controllable by the user through manipulation of the pickup selector switch 62. The piezo pickups are used in combination with a particular selection to make the guitar have more of an acoustic guitar sound.

It is understood that while many of the embodiments herein describe an electronic assembly configured as a given guitar family and the emulation of specific guitar families, that these are by way of example and that other known guitar families not specifically mentioned herein may be emulated.

Referring next to FIG. 9, an electrical circuit diagram of suitable circuitry 90 for one embodiment of an electronic assembly for an electric guitar. In this case, the electronic assembly for the guitar is configured to be a guitar having three single coil magnetic pickups, like the guitar 16 of the Stratocaster® family illustrated in FIG. 4. Generally, through user manipulation of user controls, the circuitry of this embodiment will emulate the tonalities of various electric guitars by combinations of two different means: 1) series and/or parallel wiring of the coil pickups, and 2) RLC passive filter networks. The circuitry 90 uses a given set of coil pickups and associated frequency filtering networks to selectively mimic the tonal output of multiple instruments each different types of magnetic pickup and associated RC volume and tone circuits.

There are eight primary groups of components in the circuitry 90: an array of magnetic coil pickups 34 (one embodiment of the coil pickups 61), an optional piezo pickup(s)/preamplifier 35, a 5-position blade pickup selector switch 36 (one embodiment of the pickup selector switching circuit 66), a 3 or 4 position rotary “guitar mode” or family selector switch 37 (one embodiment of the family selector switching circuit 67), a passive RLC filter circuit 38 (one embodiment of the filter circuits 68), a tone filter circuit 39 (one embodiment of circuit 69), a volume control circuit 40 (one embodiment of circuit 70), and an output connector 41. The magnetic coil pickups 34 and optional piezo pickup(s)/preamplifier 35 output a low voltage AC signal when the instrument strings vibrate. The pickup selector switch 36 and family selector switch 37 work in tandem to combine the pickup AC signals in series and/or parallel effective circuits as appropriate per each desired “guitar mode” or “family” and “pickup selection” along with assigning specific RLC passive filter networks. The resulting AC signal is then fed to the variable attenuation passive low-pass filter of the tone filter circuit 39 and variable attenuation to ground volume control circuit 40. The resulting AC signal is then routed to the output connector 41 where the signal is inputted into currently available amplification and loudspeakers to produce desired volume.

When the family selector switch 37 is in full counter-clockwise position (as shown in the schematic, i.e., connected to nodes 1, 5, 9, 25, 29, 33, 49, 53 and 57) defined as Stratocaster® family emulation mode, the family selector switch 37 works with the pickup selector switch 36 to arrange the three available single coil pickups to appear as the three single coil pickups of the Stratocaster® family. In this position, the filter circuit 38 provides a 500 k-ohm resistor (R1) in parallel to the 500 k-ohm volume potentiometer (R6) to effectively emulate the frequency response a 250 k-ohm volume control pot of the typical Stratocaster® guitar of FIG. 1 (in this case, no capacitance is needed in this branch of the filter circuit 38). While in this mode and when the pickup selector switch is placed in position 1 (as shown in the schematic, i.e., nodes 1, 7, 17 and 23 are connected), the bridge position magnetic coil pickup alone is connected between ground and the tone 39/volume 40 circuit input (referred to hereafter as “prime”). Position 2 of the pickup selector switch (position to the left of Position 1 in the schematic, i.e., nodes 2, 8, 16 and 22) connects the bridge and middle position magnetic pickups in parallel to one another between ground and prime. Position 3 (position to the left of Position 2 in the schematic, i.e., nodes 3, 9, 15 and 21) connects the middle magnetic coil pickup between ground and prime. Position 4 (position to the left of Position 3 in the schematic, i.e., nodes 4, 10, 14 and 20) connects middle and neck position magnetic pickups in parallel to one another between ground and prime. Position 5 (position to the left of Position 4 in the schematic, i.e., nodes 5, 11, 13 and 19) connects the neck position magnetic pickup between ground and prime.

Moving the rotary family selector switch 37 to the 2^{nd} position (next position clockwise to position 1, i.e., nodes 2, 6, 10, 26, 30, 34, 50, 54 and 58) invokes circuitry that produces sound characteristics similar to that of the Telecaster® family of FIG. 2. That is, the family selector switch 37 works with the pickup selector switch 36 to arrange the three available single coil pickups to appear as the two single coil pickups of the Telecaster® family. In this position, the filter circuit 38 places a RC passive low-pass filter network (R2 and C2) between ground and prime so as to shift the resonant frequency to 20 Hz less than that in the 1^{st} position for the Stratocaster® family emulation mode. While in this mode and when the pickup selector switch 36 is placed in Position 1 (as shown in the schematic), the bridge position magnetic coil pickup is connected between ground and prime to emulate a Fender® Telecaster® single-coil bridge pickup. Position 2 of the pickup selector switch 36 connects the bridge and neck position magnetic coil pickups in series with one another between ground and prime to emulate a Fender® Telecaster® Wide-Range humbucker bridge pickup. Position 3 of the pickup selector switch 36 connects the bridge and neck position magnetic coil pickups in parallel with one another between ground and prime to emulate a Fender® Telecaster® single-coil bridge and neck single-coil pickup combination. Position 4 of the pickup selector switch 36 connects the neck and middle magnetic coil pickup in series with one another between ground and prime with a 0.1 uF capacitor (C5) connected from ground to the intermediate node between the two magnetic pickups to emulate a Fender® Telecaster® Thinline Wide-Range humbucker neck pickup. Position 5 of the pickup selector switch 36 connects the neck position magnetic coil pickup only between ground and prime to emulate a Fender® Telecaster® single-coil neck pickup.

Moving the family selector mode switch 37 to the third position (one position further clockwise than the 2^{nd}, i.e., nodes 3, 7, 11, 27, 31, 35, 51, 55 and 59) invokes circuitry that produces sound characteristics similar to that of a Fender® guitar with two humbucking pickups or Gibson® guitars that use two humbucking pickups such as the Les Paul® family of FIG. 3. That is, the family selector switch 37 works with the pickup selector switch 36 to arrange the three available single coil pickups to appear as the two humbucking pickups or P-90 single coil pickups of the Les Paul® family. This mode is referred to the “power” mode. In this position, the filter circuit 38 places a RC passive filter network (R3 and C3) between ground and prime so as to reduce the resonant frequency by approximately 50 Hz to effectively emulate the frequency response of a typical Stratocaster® guitar equipped with dual humbucker pickups and/or a Stratocaster® guitar equipped with dual P-90 style pickups. While in this mode and when the pickup selector switch 36 is placed in position 1, the bridge and middle position magnetic coil pickups are connected in series between ground and prime to emulate a humbucker pickup in the bridge position. Position 2 of the pickup selector switch 36 connects a parallel neck and middle magnetic pickup circuit in series with the bridge position magnetic pickup between ground and prime to emulate a P-90 style pickup in the bridge position. Position 3 of the pickup selector switch 36 connects the bridge, middle and neck position magnetic pickups in series with one another between ground and prime to emulate a combination pickup configuration found on the Gibson® Les Paul® Custom Black Beauty Model. Position 4 of the pickup selector switch 36 connects a parallel bridge and middle magnetic pickup circuit in series with the neck position magnetic pickup between ground and prime to emulate a P-90 style pickup in the neck position. Position 5 of the pickup selector switch 36 connects the neck and middle position magnetic pickups in series with one another between ground and prime to emulate a humbucker pickup in the bridge position.

Moving the family selector switch 37 to the fourth position (1 position clockwise from the 3^{rd} position, i.e., nodes 4, 8, 12, 28, 32, 36, 52, 56 and 60) which is also referred to as semi-hollow body mode, employs the pickups in an RCL passive filter network (R4, C4) between ground and prime so as to attenuate the frequency response by approximately 8 dB at 370 Hz to effectively emulate the frequency response of a G & L Legacy® Semi-Hollow body guitar equipped with two or three humbucker pickups and/or a G & L Legacy® Semi-Hollow body guitar equipped with dual P-90 style pickups. While in this mode and when the selector switch 36 is placed in position 1, the bridge and middle position magnetic pickups are connected in series between ground and prime with a 0.1 uF capacitor (C5) connected from ground to the intermediate node between the two magnetic pickups to emulate a humbucker pickup in the bridge position of a hollowbody guitar. Position 2 of the selector switch 36 connects a parallel neck and middle magnetic pickup circuit in series with the bridge position magnetic pickup between ground and prime with a 0.1 uF capacitor (C5) connected from ground to the intermediate node between the bridge position magnetic pickup and parallel pickup combination to emulate a P-90 style pickup in the bridge position of a hollowbody guitar. Position 3 of the selector switch 36 connects the bridge, middle and neck position magnetic pickups in series with one another between ground and prime with a 0.1 uF capacitor (C5) connected from ground to the intermediate node between the first two magnetic pickups to emulate a combination of humbucker and P-90 style pickup tones in a hollowbody guitar. Position 4 of the selector switch 36 connects a parallel bridge and middle magnetic pickup circuit in series with the neck position magnetic pickup between ground and prime with a 0.1 uF capacitor (C5) connected from ground to the intermediate node between the neck position magnetic pickup and parallel pickup combination to emulate a P-90 style pickup in the neck position of a semi-hollow body guitar. Position 5 of the selector switch 36 connects the neck and middle position magnetic pickups in series with one another between ground and prime a 0.1 uF capacitor (C5) connected from ground to the intermediate node between the two magnetic pickups to emulate a humbucker pickup in the neck position of a semi-hollow body guitar.

It is noted that the circuit 90 of FIG. 9 also illustrates a piezo port 81, an accessory port 82 and a five-way pickup switch port 83. These ports function as simple interconnection components that are understood in the art.

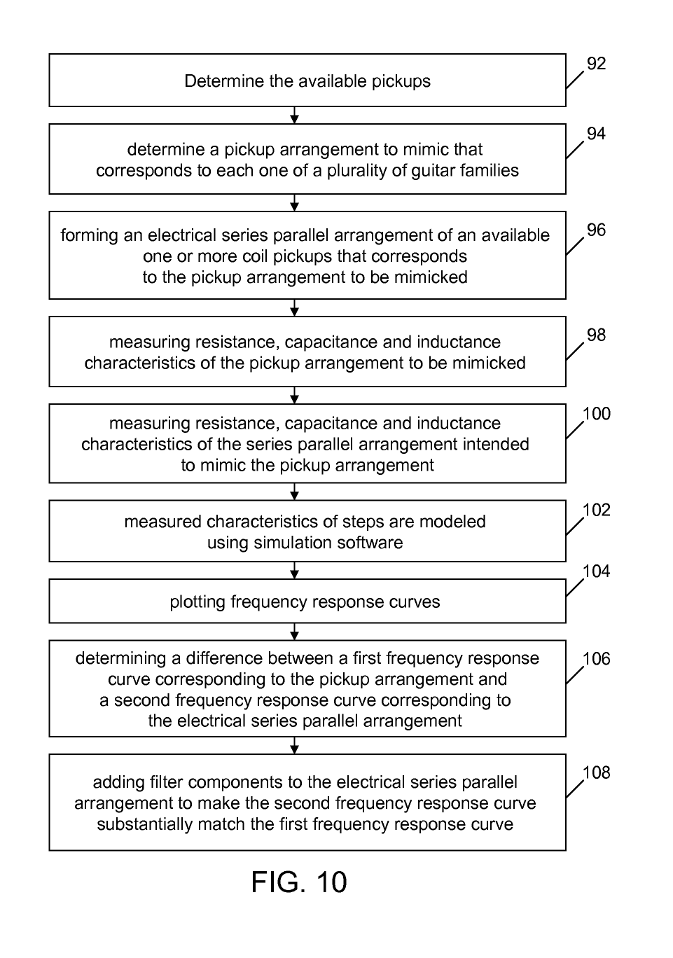

Referring next to FIG. 10, a flowchart is shown that illustrates steps performed in accordance with several embodiments of the invention. According to several embodiments, this method will allow one to design an electronic assembly configured as a guitar of a particular guitar family but that can mimic the intonation or sound of guitars from one or more additional guitar families, through user manipulation of a guitar family selector switch.

Starting with an electronic assembly for a guitar of a given family, the designer determines the available coil pickups (Step 92). For example, with a guitar based on the Stratocaster® guitar family, the designer has available three single coil pickups. If the guitar is based on the Telecaster® family or the Les Paul® family, the designer has two single coil pickups or two or more humbucking pickups (or two or more P-90 style coil pickups) available, respectively. Note that in some cases, the available pickups might be slightly varied from the standard pickup arrangement, such as using two stacked coil pickups for the Telecaster® version as described above.

The next step is to determine a pickup arrangement to mimic that corresponds to each one of a plurality of guitar families (Step 94). For example, in some embodiments, this involves determining the desired pickup type & location to mimic. For example, if the designer intends to mimic a guitar of the Les Paul® family, in one embodiment, the designer will have to mimic a humbucker bridge coil pickup and a humbucker neck coil pickup.

The next step is to form an electrical series parallel arrangement of an available one or more coil pickups that corresponds to the pickup arrangement to be mimicked (Step 96). In some embodiments, this involves altering, through the appropriate switching circuitry, the parallel and series connection of one or more coils or portions of coils. For example, see the illustrations of FIGS. 7 and 8.

Next, the resistance, capacitance and inductance characteristics of the pickup arrangement to be mimicked is measured (Step 98). Next, the resistance, capacitance and inductance characteristics of electrical series parallel arrangement intended to mimic the pickup arrangement are measured (Step 100). Steps 98 and 100 may be accomplished using testing and monitoring equipment known in the art.

Next, the measured characteristics of steps are modeled using simulation software (Step 102) and frequency response curves are plotted (Step 104). Such software is known in the art.

Next, a difference between a first frequency response curve corresponding to the pickup arrangement and a second frequency response curve corresponding to the electrical series parallel arrangement that is intended to mimic the pickup arrangement is determined (Step 106). This should determine the amount of change needed to cause the second frequency response to substantially match the first frequency response. For example, as discussed above, in one embodiment, a difference of approximately 20 Hz was found between the first and second response curves indicating that the resonant frequency of the electrical series parallel arrangement should be adjusted by 20 Hz in order to closely mimic the pickup arrangement to be mimicked.

Next, filter components are added to the electrical series parallel arrangement to make the second frequency response curve substantially match the first frequency response curve (Step 108). In some embodiments, this involves adding the appropriate RC filter circuit and results in the determination of the filter circuits 38 and 68. In one embodiment, the following relationship is used to approximate the resistance R and capacitance C values needed to make the adjustment.

$${Freq}_{res} = \frac{1}{2 π RC}$$

For example, a particular resistance and capacitance is added to cause a change in the resonant frequency of 20 Hz. This fine tuning adjustment results in making the guitar mimic the intonation of a guitar of the desired guitar family.

Steps 92 through 108 are repeated for each guitar family to be mimicked by the electronic assembly. In this manner, the designer can develop a switching circuit, such as the circuit 90, that is specific to a particular guitar based on a particular guitar family, but that can mimic the intonation of guitars of other guitar families.

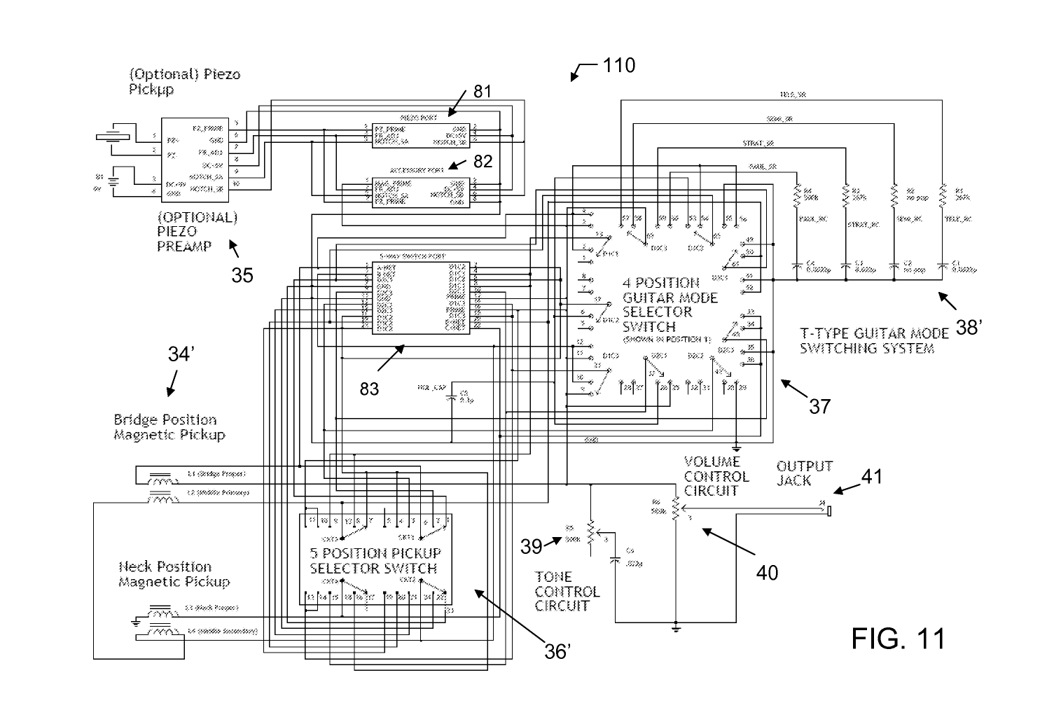

Referring next to FIG. 11, an electrical circuit diagram is shown for suitable circuitry 110 for another embodiment of an electronic assembly for an electric guitar based on a guitar family generally having two single coil pickups, such as the Telecaster® family. This switching circuit is generally similar in operation to the switching circuit 90 of FIG. 9; however, the available pickups are two stacked double coil pickups such as illustrated in FIGS. 7 and 8. Like the circuitry 90, through user manipulation of user controls, the circuitry of this embodiment will emulate the tonalities of various electric guitars by combinations of two different means: 1) series and/or parallel wiring of the coil pickups, and 2) RLC passive filter networks. The circuitry 110 uses a given set of coil pickups and associated frequency filtering networks to selectively mimic the tonal output of multiple instruments each different types of magnetic pickup and associated RC volume and tone circuits.

The same or similar basic components are used in circuitry 110 as in circuitry 90. Same components share the same reference numeral while similar components are labeled with the same reference numeral prime. Thus, the circuitry 110 includes an array of magnetic coil pickups 34′ (two stacked double coil pickups), the optional piezo pickup(s)/preamplifier 35, a 5-position blade pickup selector switch 36′ (one embodiment of the pickup selector switching circuit 66), a 4 position rotary “guitar mode” or family selector switch 37 (one embodiment of the family selector switching circuit 67), a passive RLC filter circuit 38′ (one embodiment of the filter circuits 68), the tone filter circuit 39 (one embodiment of circuit 69), the volume control circuit 40 (one embodiment of circuit 70), and the output connector 41. The circuitry functions generally similar to the circuitry 90 excepts that the components are wired together such that the circuit mimics the desired guitar families with a different set of coil pickups.

When the family selector switch 37 is in full counter-clockwise position (as shown in the schematic, i.e., connected to nodes 1, 5, 9, 25, 29, 33, 49, 53 and 57), the circuit 110 is in Telecaster® family emulation mode, the family selector switch 37 works with the pickup selector switch 36′ to arrange the coils of the two available stacked coil pickups to appear as the two single coil pickups of the Telecaster® family and works with the appropriate RC filter (R1, C1) to emulate the intonation of the Telecaster® family.

Moving the rotary family selector switch 37 to the 2^{nd} position (next position clockwise to position 1, i.e., nodes 2, 6, 10, 26, 30, 34, 50, 54 and 58) invokes circuitry that produces sound characteristics similar to a semi-hollow body mode and employs the pickups in an RCL passive filter network (R2, C2) to effectively emulate the frequency response of a G & L Legacy® Semi-Hollow body guitar equipped with two or three humbucker pickups and/or a G & L Legacy® Semi-Hollow body guitar equipped with dual P-90 style pickups.

Moving the family selector mode switch 37 to the third position (one position further clockwise than the 2^{nd}, i.e., nodes 3, 7, 11, 27, 31, 35, 51, 55 and 59), the circuit 110 is in Stratocaster® family emulation mode, the family selector switch 37 works with the pickup selector switch 36′ to arrange the coils of the two available stacked coil pickups to appear as the three single coil pickups of the Stratocaster® family and works with the appropriate RC filter (R3, C3) to emulate the intonation of the Stratocaster® family.

Moving the family selector switch 37 to the fourth position (1 position clockwise from the 3^{rd} position, i.e., nodes 4, 8, 12, 28, 32, 36, 52, 56 and 60) invokes circuitry to produce sound characteristics of the Les Paul® family of FIG. 3. That is, the family selector switch 37 works with the pickup selector switch 36′ to use the coils of the two available stacked coil pickups and the appropriate filter (R4, C4) to output the sound of the Les Paul® family.

Once the family selector switch 37 is in a particular mode, manipulation of the pickup selector switch 36′ will cause the circuit to arrange the available coils of the pickups 34′ to emulate the sound of a given pickup or pickups of the emulated guitar family, similar to the process described in connection with FIG. 9, for example using various series parallel arrangements of available coils and filtering components. One of ordinary skill in the art can understand that how such switching is accomplished by inspection of the illustrated circuitry; thus, this detailed description is omitted herein. It is noted that some values in the filter circuit 38″ are labeled as “no pop” since they are not necessary with the particular brand and characteristic pickups used. However, a resistor and capacitor may be needed depending on the characteristics of the particular pickups to be used, the values of which may be derived in several ways, for example, by following the approach described in FIG. 10.

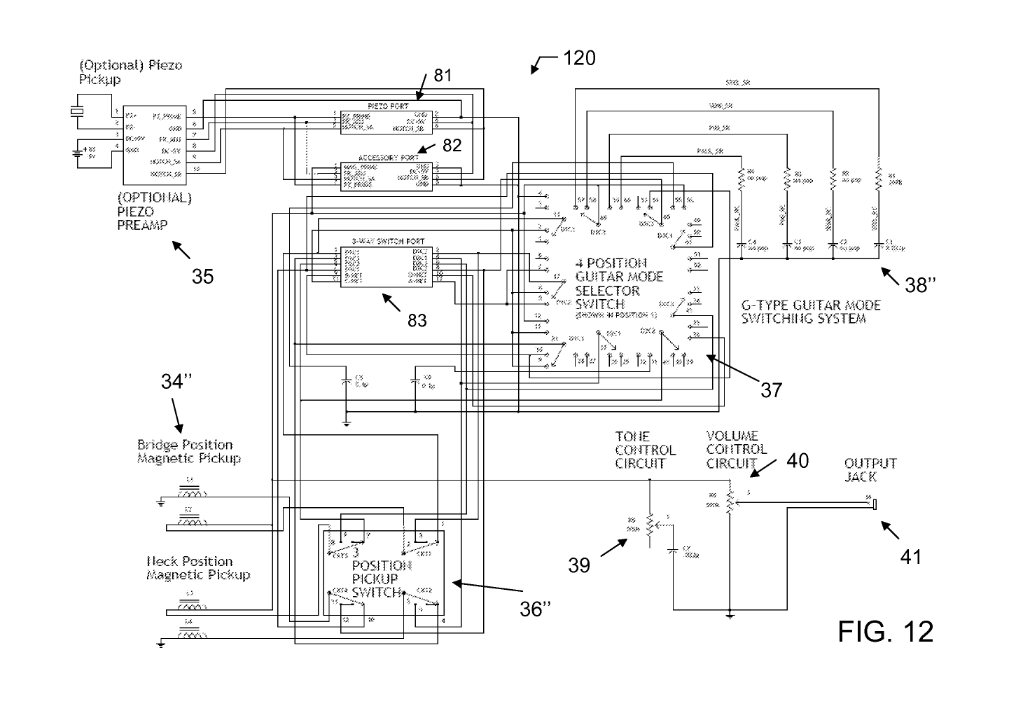

Referring next to FIG. 12, an electrical circuit diagram is shown for suitable circuitry 120 for another embodiment of an electronic assembly for an electric guitar based on a guitar family generally having two humbucking double coil pickups. This switching circuit is generally similar in operation to the switching circuit 90 of FIG. 9; however, the available pickups are two humbucking double coil pickups 34 like the Les Paul® family of FIG. 3. Like the circuitry 90, through user manipulation of user controls, the circuitry of this embodiment will emulate the tonalities of various electric guitars by combinations of two different means: 1) series and/or parallel wiring of the coil pickups, and 2) RLC passive filter networks. The circuitry 120 uses a given set of coil pickups and associated frequency filtering networks to selectively mimic the tonal output of multiple instruments each different types of magnetic pickup and associated RC volume and tone circuits.

The same or similar basic components are used in circuitry 120 as in circuitry 90. Same components share the same reference numeral while similar components are labeled with the same reference numeral double prime. Thus, the circuitry 120 includes an array of magnetic coil pickups 34″ (two humbucking double coil pickups), the optional piezo pickup(s)/preamplifier 35, a 3-position blade pickup selector switch 36″ (one embodiment of the pickup selector switching circuit 66), a 4 position rotary “guitar mode” or family selector switch 37 (one embodiment of the family selector switching circuit 67), a passive RLC filter circuit 38″ (one embodiment of the filter circuits 68), the tone filter circuit 39 (one embodiment of circuit 69), the volume control circuit 40 (one embodiment of circuit 70), and the output connector 41. The circuitry functions generally similar to the circuitry 90 excepts that the components are wired together such that the circuit mimics the desired guitar families with a different set of coil pickups.

When the family selector switch 37 is in full counter-clockwise position (as shown in the schematic, i.e., connected to nodes 1, 5, 9, 25, 29, 33, 49, 53 and 57), the circuit 120 is in Stratocaster® family emulation mode, the family selector switch 37 works with the pickup selector switch 36″ to arrange the coils of the two available humbucking coil pickups to appear as the three single coil pickups of the Stratocaster® family and works with the appropriate RC filter (R1, C1) to emulate the intonation of the Stratocaster® family.

Moving the rotary family selector switch 37 to the 2^{nd} position (next position clockwise to position 1, i.e., nodes 2, 6, 10, 26, 30, 34, 50, 54 and 58) invokes circuitry that produces sound characteristics similar to a semi-hollow body mode and employs the pickups in an RCL passive filter network (R2, C2) to effectively emulate the frequency response of a G & L Legacy® Semi-Hollow body guitar equipped with two or three humbucker pickups and/or a G & L Legacy® Semi-Hollow body guitar equipped with dual P-90 style pickups.

Moving the family selector mode switch 37 to the third position (one position further clockwise than the 2^{nd}, i.e., nodes 3, 7, 11, 27, 31, 35, 51, 55 and 59) invokes circuitry that produces sound characteristics similar to that of a Les Paul® family guitar having two P-90 style single coil pickups. That is, the family selector switch 37 works with the pickup selector switch 36″ to arrange the coils of the two available humbucking pickups to appear as the two P-90 style single coil pickups of the Les Paul® family and uses the appropriate RC passive filter (R3, C3) to emulate the sound of this family.

Moving the family selector switch 37 to the fourth position (1 position clockwise from the 3^{rd} position, i.e., nodes 4, 8, 12, 28, 32, 36, 52, 56 and 60) invokes circuitry to produce sound characteristics of the Les Paul® family of FIG. 3. That is, the family selector switch 37 works with the pickup selector switch 36″ to use the two available humbucking pickups and the appropriate filter (R4, C4) to output the sound of the Les Paul® family.

Once the family selector switch 37 is in a particular mode, manipulation of the pickup selector switch 36″ will cause the circuit to arrange the available coils of the pickups 34″ to emulate the sound of a given pickup or pickups of the emulated guitar family, similar to the process described in connection with FIG. 9, for example, using various series parallel arrangements of available coils and filtering components. One of ordinary skill in the art can understand that how such switching is accomplished by inspection of the illustrated circuitry; thus, this detailed description is omitted herein. It is further noted that some values in the filter circuit 38″ are labeled as “no pop” since these values have yet to be determined for this configuration. However, these values may be derived in several ways, for example, by following the approach described in FIG. 10.

While the invention herein disclosed has been described by means of specific embodiments, examples and applications thereof, numerous modifications and variations could be made thereto by those skilled in the art without departing from the scope of the invention set forth in the claims.

1. An electronic assembly for use with an electric guitar comprising:
one or more coil pickups;
a pickup selector switching circuit coupled to the one or more coil pickups and operable to engage a whole and/or a portion of a coil pickup individually as well as to engage combinations of two or more of the coil pickups;
a volume control circuit;
a family selector switch; and
a family selector switching circuit coupled to the family selector switch and the pickup selector switching circuit, wherein user manipulation of the family selector switch changes an intonation of the electric guitar so as to alternately mimic a characteristic sound of each of a plurality of guitar families.

2. The assembly of claim 1 wherein user manipulation of the family selector switch causes the family selector switching circuit and the pickup selector switching circuit to establish a predetermined electrical arrangement of the one or more coil pickups to mimic a respective pickup arrangement corresponding to each of the plurality of guitar families.

3. The assembly of claim 2 wherein user manipulation of the family selector switch causes the family selector switching circuit to selectively engage the whole and/or the portion of the coil pickup individually as well as to selectively engage combinations of the two or more of the coil pickups in predetermined series and/or parallel electrical arrangements with corresponding filter circuits to mimic the characteristic sound of each of a plurality of guitar families.

4. The assembly of claim 2 further comprising:
filter circuits coupled to the family selector switching circuit, the filter circuits operable together with the family selector switching circuit and the predetermined electrical arrangement of the one or more pickups to cause the change of the intonation so as to alternately mimic the characteristic sound of each of the plurality of guitar families.

5. The assembly of claim 4 wherein the filter circuitry is passive.

6. The assembly of claim 4 wherein each of the filter circuits comprises a resistance, capacitance and inductance circuit and corresponds to one of the plurality of guitar families.

7. The assembly of claim 1 wherein the family selector switch comprises a single user controllable switch.

8. The assembly of claim 7 wherein the single user controllable switch comprises a single rotatable switch.

9. The assembly of claim 1 wherein the family selector switch is substituted for an existing user control of a conventional electric guitar.

10. The assembly of claim 1 further comprising at least one tone control circuit.

11. The assembly of claim 1 further comprising a pickup selector switch coupled to the pickup selector switching circuit, wherein user manipulation of the pickup selector switch causes the engagement of the whole and/or the portion of the coil pickup individually as well as to cause the engagement of combinations of two or more of the coil pickups.

12. The assembly of claim 1 wherein the one or more coil pickups comprises three single coil pickups and wherein the assembly further comprises a five way pickup selector switch coupled to the pickup selector switching circuit,
wherein user manipulation of the family selector switch changes the intonation of the electric guitar so as to alternately mimic a characteristic sound of each of (1) a first guitar family characterized by having three single coil pickups, (2) a second guitar family characterized by having two single coil pickups and (3) a third guitar family characterized by having two or three humbucking coil pickups.

13. The assembly of claim 12 wherein assembly is for use with the electric guitar modeled after a Fender® Stratocaster® family of guitars.

14. The assembly of claim 1 wherein the one or more coil pickups comprises two stacked coil pickups, and wherein the assembly further comprises a three way pickup selector switch coupled to the pickup selector switching circuit,
wherein user manipulation of the family selector switch changes the intonation of the electric guitar so as to alternately mimic a characteristic sound of each of (1) a first guitar family characterized by having three single coil pickups, (2) a second guitar family characterized by having two single coil pickups and (3) a third guitar family characterized by having two or three humbucking coil pickups.

15. The assembly of claim 14 wherein assembly is for use with the electric guitar modeled after a Fender® Telecaster® family of guitars.

16. The assembly of claim 1 wherein the one or more coil pickups comprises two or three humbucking coil pickups or two or three P-90 style single coil pickups and wherein the assembly further comprises a three or more way pickup selector switch coupled to the pickup selector switching circuit,
wherein user manipulation of the family selector switch changes the intonation of the electric guitar so as to alternately mimic a characteristic sound of each of (1) a first guitar family characterized by having three single coil pickups, (2) a second guitar family characterized by having two single coil pickups and (3) a third guitar family characterized by having two or three humbucking coil pickups.

17. The assembly of claim 16 wherein assembly is for use with the electric guitar modeled after a Les Paul® family of guitars.

18. The assembly of claim 1 wherein user manipulation of the family selector switch causes the pickup selector switching circuit to engage a respective coil of a double coil pickup.

19. The assembly of claim 1 wherein user manipulation of the family selector switch causes the pickup selector switching circuit to engage a portion of a respective coil pickup using a coil tap.

20. The assembly of claim 1 further comprising a pickguard, wherein the one or more coil pickups; the pickup selector switching circuit, the volume control circuit, the family selector switch and the family selector switching circuit are mounted to the pickguard as insertion into a guitar body.

21. The assembly of claim 1 further comprising one or more piezo electric pickups coupled to the pickup selector switching circuit, wherein user manipulation of the family selector switch can select the one or more piezo-electric pickups in combination with selection of one of said plurality of guitar families to give the electric guitar more of an acoustic guitar sound.

22. A method of operating an electric guitar comprising:
manipulating a pickup selector switch of the electric guitar to cause the electric guitar to selectively engage one or more of a plurality of coil pickups; and
manipulating a family selector switch of the electric guitar to change an intonation of the electric guitar so as to alternately mimic a characteristic sound of each of a plurality of guitar families.

23. A method of operating an electric guitar comprising:
selectively engaging one or more of a plurality of coil pickups of an electric guitar; and
selectively establishing a predetermined electrical arrangement of the one or more coil pickups to mimic a respective pickup arrangement corresponding to a selectable one of a plurality of guitar families;
filtering signaling received from the predetermined electrical arrangement of the one or more coil pickups using a predetermined filter corresponding to the selectable one of the plurality of guitar families;
adjusting a volume of the signaling; and
outputting the signaling to audio equipment.

24. A method of designing an electronic assembly for use in an electric guitar comprising:
(a) determining a pickup arrangement to mimic that corresponds to each one of a plurality of guitar families; and
for each pickup arrangement,
(b) forming an electrical series parallel arrangement of an available one or more coil pickups that corresponds to the pickup arrangement;
(c) measuring resistance, capacitance and inductance characteristics of the pickup arrangement to be mimicked;
(d) measuring resistance, capacitance and inductance characteristics of electrical series parallel arrangement intended to mimic the pickup arrangement;
(e) modeling the measured characteristics of steps (c) and (d);
(f) plotting frequency response curves based on step (e);
(g) determining a difference between a first frequency response curve corresponding to the pickup arrangement and a second frequency response curve corresponding to the electrical series parallel arrangement; and
(h) adding filter components to the electrical series parallel arrangement to make the second frequency response curve substantially match the first frequency response curve.
